(19) United States
(12) Patent Application Publication
(10) Pub. No.: US 2009/0307349 A1
(43) Pub. Date: Dec. 10, 2009

(54) SYSTEM AND METHOD FOR COMMUNICATION BASED ON AN AVAILABILITY OF A USER

(75) Inventors: John M. Harris, Glenview, IL (US); Sean S. Kelley, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/471,507

(22) Filed: May 26, 2009

Related U.S. Application Data
(60) Provisional application No. 61/060,242, filed on Jun. 10, 2008.

(51) Int. Cl. G06F 15/173

(52) U.S. Cl. 709/224; 709/225

(57) ABSTRACT

The present invention provides a system and method for communication based on an availability level of a presence entity in a communication network that includes a first step (400) of configuring at least one privacy rule for a communication service, wherein the at least one privacy rule is associated with the presence entity and assigns a potential caller to a prioritized group. A next step (402) includes receiving an indication of availability of the presence entity. A next step (404) includes controlling communication access with the presence entity based on the at least one privacy rule, wherein communication access between the presence entity and the caller is controlled by the priority for that caller and the availability indication of the presence entity.

### FIELD OF THE INVENTION

The field of the invention relates to communication networks, and in particular, to a system and method for communication based on an availability of a user in a communication network.

### BACKGROUND OF THE INVENTION

Watchers in presence-enabled networks typically examine the presence state of presence entities (e.g., human users or help desks) operating within these networks in order to determine whether these presence entities are available or unavailable to receive communications. The presence state is typically transmitted to the watcher device by a presence service and, based upon this state, contact with the presence entity (presentity) may be either encouraged or discouraged. The presence state may be available, unavailable, or conditionally available (e.g., available/unavailable, but qualified by certain conditions such as “if work related”). Other examples of presence states are possible.

In some call situations involving many watchers, the presence service will notify all watchers of a particular presence entity of a change of presence state of that particular presence entity. This is not a problem if the presence entity has changed state to become unavailable. However, difficulties can arise when group of watchers are notified that the presence entity has changed to an available state. Specifically, if more than one watcher wishes to contact the presence entity, upon a change to an available state, the presence entity may be deluged with numerous calls, particularly so where an automatic redial service is used. Therefore, after the presence entity (e.g. mobile station MS user) becomes newly available for service, a large number of pent-up call requests are likely to be sent to that MS.

For example, using an invitation reservation service/automatic redial service, callers can request that a call be placed automatically to an MS as soon as the MS becomes available, which can burden the MS with multiple calls immediately upon becoming available (e.g. powering on the MS). In another example, a user who powers up their mobile phone may wish to initiate a call at that time, but instead would be immediately interrupted with incoming calls. In yet another example, an MS can be in an automatic accept mode, where the MS automatically accepts the first incoming Push-To-Talk (PTT) call without user intervention, and may receive a call from someone the user does not wish to speak to at that time. In all of these above examples, the user is exposed to a less than desirable experience dealing with a low priority communication, and the user must either accept this lower priority call and/or explain to the lower priority caller that the user desires to drop that lower priority call to either take or place another higher priority call, neither of which is desirable.

A presence entity MS may in particular experience a call surge as described above when exiting from a longer period of unavailability, such as when the MS has been powered off, the MS was outside of a coverage area (e.g. a tunnel or a plane), the MS is just exiting a meeting, or the MS has been busy on a lengthy call. Since in many situations the problems occurred in a work environment, worker productivity is also adversely affected, which is undesirable.

As a consequence of the above-mentioned problems, the user experience in such above situations is undesirable, and it would be advantageous to find a solution to alleviate the above problems.

### BRIEF DESCRIPTION OF THE DRAWINGS

FIG. 1 is a block diagram of a presence service for a presence entity and a plurality of potential callers, in accordance with the present invention;

FIG. 2 is a timing diagram demonstrating a first aspect of the present invention;

FIG. 3 is a timing diagram demonstrating a second aspect of the present invention; and

FIG. 4 is a flow diagram of a method in accordance with the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

The present invention extends privacy rules for a communication service to alleviate the aforementioned problems, as will be described in detail below. In the embodiments described herein, an availability is associated with a presence entity (i.e. a human user or presentity), and is received, for example, at a communication service which is operable to control communication access between the presence entity and callers or watchers (e.g. other MS users) who wish to contact the user. The availability indicates a characteristic of a user such as the user's ability to receive communication, the user's willingness to receive communication, the user's activity, the geographical location of a user, the location type of a user, or whether the user is logged into a computer system. Other examples of availability are possible. Upon receiving the indication of availability, the communication service applies the privacy rules to control communication access.

In particular, the present invention covers two use cases: controlling dissemination of a presence entity's available status based on a priority of a watcher (using presence authorization rules); and controlling incoming communication requests (e.g. by blocking the request, or modifying the answer mode behavior of the target device) based on the priority of the request originator (using user access rules). What these two use cases have in common is the concept that the user has a priority associated with his willingness to communicate which the server (presence server in a first embodiment, or Push-to-Talk over Cellular (PoC) communication server in the second embodiment) uses to help determine which of multiple tiers of watchers/callers are encouraged/allowed to contact the presence entity. As defined herein, a communication service, which can include a presence server and/or a PoC (or IM) communication server, that enforces the privacy rules (i.e. the presence authorization rules or user access rules, respectively).

The privacy rules assign potential callers to different tiers according to priority. Upon receiving an indication that a presence entity has become available, the communication service can then delay calls from callers to the presence entity in accordance with the tier priorities. The delays for each tier can be predefined in the privacy rules or determined empirically by the communication service. Preferably, at a particular time the communication service can instead receive an availability level from the presence entity that defines a particular tier, whereupon the communication service can then permit call access to the presence entity for callers in that particular tier. In this way, the presence entity can control the particular times when it will start accepting calls from each tier, instead of having the communication service decide this.

In operation, the presence source can publish an availability level that is used when evaluating the privacy rules to determine what caller (tier) is authorized. For example, the communication service might receive an indication that the presence entity is available but that the availability level is only to a high priority (tier) caller, or the communication service might receive an indication that the presence entity is available but that the availability level is only to high and mid priority (tier) callers, or the communication service might receive an indication that the presence entity is available and that the availability level is to high, mid, and low priority (tier) callers. Alternatively, different availability level communications can be sent by the presence entity to the communication service at different times for different caller (tiers). Additionally, the availability level can have an expiration, or the presence source cancels the publication of availability level to the communication service, so that in the absence of an availability level the default for the presence server is “available to all callers”.

In a first embodiment, the presence entity configures presence authorization rules that can be automatically processed by the communication service (i.e. presence server). The presence authorization rules are expressed in XML and determine whether to provide presence information (i.e. an availability indication) to watchers, based in part on the degree or level of willingness of the presence entity to communicate with watchers of various importance by priority. The advantage is that if the rules are automatically processed by the presence server, the operation of the presence authorization rules becomes transparent to the watcher and the watcher does not become aware of the priority assigned to him by the presence entity. Rather than having presence authorization rules configured statically into the presence server, the presence entity can dynamically create and push the rules to the server, where the rules are then processed. This is advantageous because: a) the presence entity (not the presence server) is often the best suited for creating rules, since it alone knows the precise semantics of the information and the nature of the device publishing it, and b) the presence server (not the watcher) is often the best suited for processing the rules, because knowledge of the rules and any conflicts with other rules can best be handled by the presence server.

In a second embodiment, the presence entity configures the user access rules that can be automatically processed by a communication service (i.e. a communication server, such as a PoC Server, IM Server, etc). The user access rules are expressed in XML and determine how the communication server handles incoming communication requests, based in part on the degree or level of willingness of the presence entity to communicate with callers of various importance by priority. However, it should be recognized that the user access rules could reside in a user device. Specifically, user access rules which determine, for example, whether an incoming request for PoC communication is automatically answered or manually answered may reside on the presence entity's device (but preferably resides in the communication server as an extension to the stored user access rules), whereas the presence authorization rules of the first embodiment must reside on a presence server. It should be noted that the first and second embodiments are not mutually exclusive and can co-exist in the communication service.

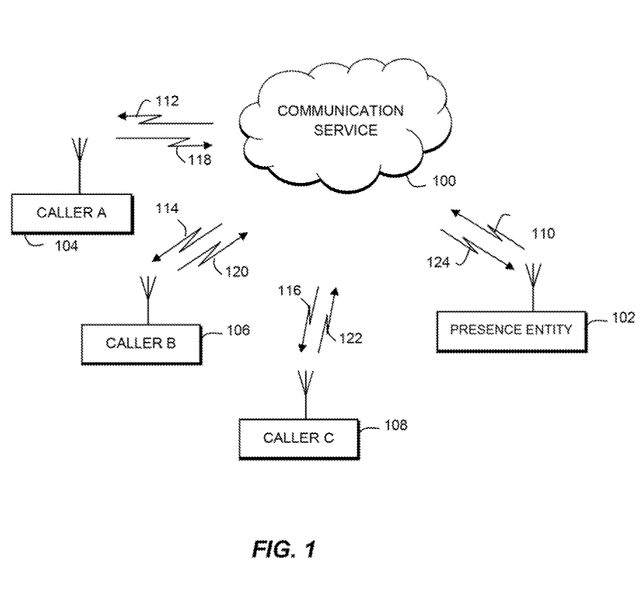

Referring now to FIG. 1, the first embodiment for implementing privacy rules, in this case presence authorization rules, in accordance with the present invention is described. A user 102 is a presence entity that has associated with it a presence source being a communication device such as a mobile station, computer, personal digital assistant, and the like. The user can be associated with a group of buddies 102, 104, 106, 108 that exchange presence information with a communication service 100 that includes a presence server. The presence source provides presence information such as the user's availability or availability level to the presence server, and the presence server distributes presence information for all the members of the group. In the example shown, one user, presence entity 102 has been unavailable to a group of callers 104, 106, 108, referred to as watchers in this embodiment, and has now become available for communication with the watchers 104, 106, 108, who have been waiting for user 102 to become available for communication. As used herein, a “watcher” can be other users, or can be a service or application, waiting to communicate with a particular presence entity 102.

In accordance with the present invention, presence entity 102 passes a desired set of presence authorization rules 110 to the presence server. This can be accomplished by using an XML Document Management Client (XDMC) to create/modify presence authorization rules stored on a Presence XML Document Management Server (XDMS), which can be operably coupled with the presence server as described in the OMA Presence SIMPLE architecture, which is known in the art and need not be described here. Upon the presence entity becoming available, the presence server of the communication service 100 can control communication access by notifying 112, 114, 116 members of the group (i.e. watchers 104, 106, 108) of the change of state of the presence entity to “available”, in accordance with the presence authorization rules configured by the presence entity 102. In response to the indication of availability in accordance with the presence authorization rules, the watchers of the presence entity can then place a call 118, 120, 122, 124 to the presence entity if desired. The call may be placed manually by users associated with watchers 104, 106, and 108, or by an automatic redial service wherein callers 102, 104, 106 register their desire to place a call 118, 120, 122 to a particular user 102 when that user becomes available, whereupon the communication service will place the call 124 automatically upon the presence entity becoming available. The various aspects of the presence authorization rules will now be described.

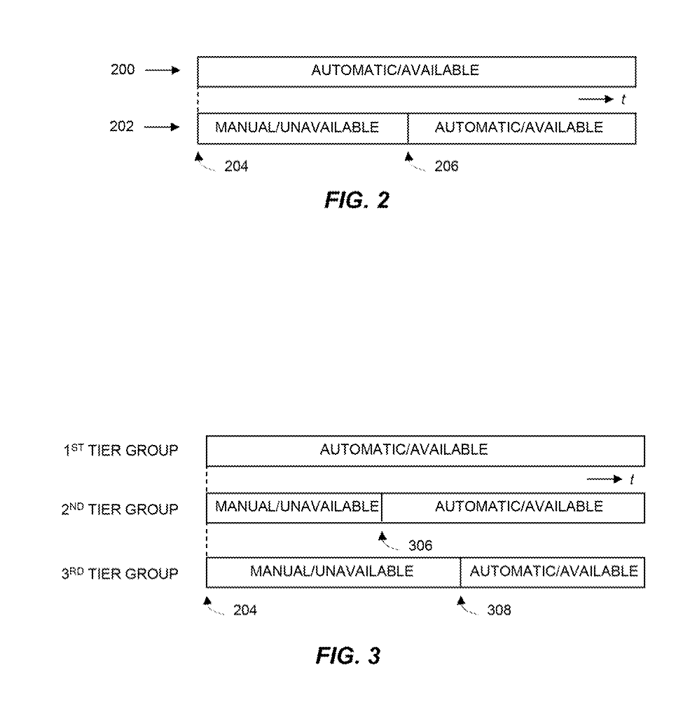

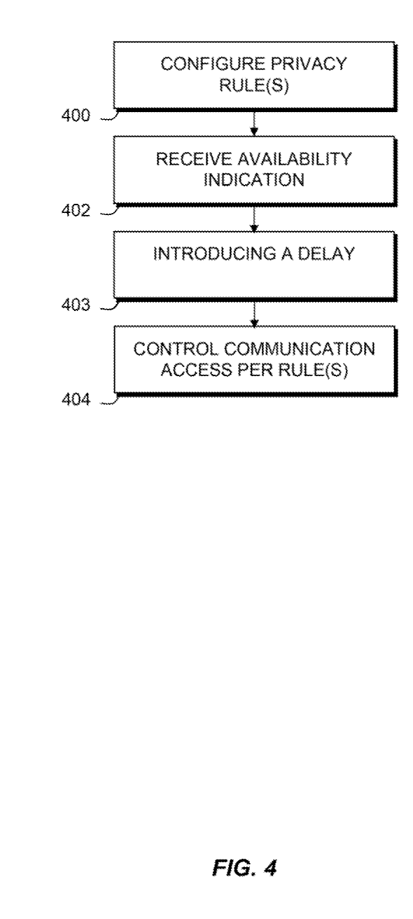

Referring now to FIG. 2, as is presently known in the art 200, at the time 204, t, when a presence entity becomes “available” that presence entity can immediately be called by any watcher that is notified of the newly available state, which can deluge the presence entity with calls that may not be desired at that particular time. The present invention 202 avoids this problem by instituting presence authorization rules where, after the presence entity becomes newly available for service 204, a delay 206 is introduced where the presence server will delay notification of the newly available state to lower priority watchers for a specified amount of time 206. These rules allow a user a period of time to initiate calls of her own, e.g. immediately after powering on her phone, or receive a desired high priority call, and avoids the situation of immediately receiving an undesired lower priority call where the user must either accept this lower priority call and/or explain to the lower priority caller that the user desires to drop her call to either take or place another higher priority call. During this delay period 204 to 206, the presence server does not notify lower priority watchers (in accordance with the presence authorization rules) of the newly available state, but instead indicates to the specific watchers (in accordance with the presence authorization rules) that the availability state of the presence entity is either “unavailable” or unknown, even though the presence entity actually is available. During this delay period 204 to 206, even though a manual call could be placed to the presence entity, a lower priority watcher is discouraged from placing such a call due to the belief that the presence entity is not available, and thus assumes the call has a low probability of success. After the delay period 206, the presence server notifies lower priority watchers (in accordance with the presence authorization rules) of the “available” state so as to no longer discourage calls to the presence entity.

Referring to FIG. 3, preferably the first embodiment of the present invention incrementally disseminates over time a presence entity's availability per a prioritization of particular watchers (e.g. a buddy list of the presence entity). In other words, the presence entity may provide the presence server with presence authorization rules that define a priority of members of the presence entity's buddy list. For example, a first tier group (e.g. spouse, supervisor, VIPs, critical customers) can be defined that are allowed immediate access to the presence entity when it becomes available at time 204. A second tier group (e.g. peers, potential customers) can be defined where a first delay 306 is introduced that delays notifying watchers in that tier of the presence entity's newly available state for that specified amount of delay time 306, thereby discouraging calls to the presence entity during that time. A third tier group of lower priority callers (e.g. simple acquaintances, etc.) can be defined where a second delay 308 is introduced, larger than the first delay 306, that delays notifying watchers in that tier that the presence entity is newly available for a specified amount of time 308.

The delays for each tier can be predefined in the presence authorization rules or determined empirically by the presence server. Preferably, at a particular time (e.g. 306, 308) the presence server can receive an availability level from the presence entity that indicates a particular tier or tiers, whereupon the presence server can notify that particular tier or tiers of watchers of the MS's availability to take calls. Preferably, the delay times 306, 308 can be dynamically adjusted, such as shortening delay times if the presence entity has become newly available after a shorter interval of unavailability or in response to a decreasing number of watchers of that presence entity. In addition, the delay can be increased if the number of watchers or incoming calls increases, or if the presence entity has become newly available after a longer interval of unavailability. Also, the presence entity could make itself unavailable to more watchers when approaching an upcoming commitment, such as a meeting time. In addition, the presence entity can define presence authorization rules to send warnings to people for a particular future time when the presence entity will not be available.

In practice, the delay times 306, 308 can be set and adjusted by either the presence server or the presence entity. For example, a presence server-based incremental presence authorization policy can be implemented when the server detects an MS change its presence to “available”, whereupon the server notifies a first tier watcher of this availability immediately, a second tier watcher after delaying for thirty seconds (for example), and a third tier watcher after two minutes (for example). In another example, a presence entity-based incremental presence authorization policy can be implemented when the presence server receives an availability level from an MS indicating a particular tier or tiers, when the MS is ready to receive calls from that tier or tiers, whereupon the presence server notifies that particular tier or tiers of watchers of the MS's availability to take calls. The setting of particular delay times can be implemented anytime the presence entity updates any/specific presence information, e.g. becomes newly available or arrives at work.

Referring back to FIG. 1, the second embodiment for implementing privacy rules, in this case user access rules, in accordance with the present invention is described. A user 102 is a presence entity that has associated with it a presence source being a communication device such as a mobile station, computer, personal digital assistant, and the like. The user can be part of a group of buddies of potential callers 102, 104, 106, 108. The communication service 100 can provide a communication server (e.g. PoC server, IM server, etc.) to implement communication between the members of the group. In the example shown, one user, presence entity 102 has been unavailable to the group, and has now become available for communication with other members of the group, i.e. callers 104, 106, 108, who have been waiting for user 102 to become available for communication. As used herein, the communication server performs automatic answer or manual answer procedures, in accordance with the user access rules, for calls 118, 120, 122 originated by the callers 104, 106, 108.

In accordance with the present invention, presence entity 102 passes a desired set of user access rules 110 to the communication server 100. This can be accomplished by using an XML Document Management Client (XDMC) to create/modify user access rules stored on a Shared Policy XML Document Management Server (XDMS), which can be operably coupled with the PoC server as described in the OMA PoC architecture, which is known in the art and need not be described here. Upon the presence entity becoming available, the communication server of the communication service 100 can control communication access between the callers 104, 106, 108 and the presence entity 102 in accordance with the user access rules configured by the presence entity 102. In response to the indication of availability in accordance with the user access rules, any automatic or manual calls 118, 120, 122, 124 of the callers can then be received by the presence entity. The various embodiments of the user access rules will now be described.

Referring now to FIG. 2, as is presently known in the art 200, at the time 204, t, when a presence entity becomes “available” that presence entity can immediately be called by either automatic callback service of the caller or manually from any caller, which can deluge the presence entity with calls that may not be desired at that particular time. The present invention 202 avoids this problem by instituting user access rules where, after the presence entity becomes newly available for service 204, a delay 206 is introduced where the communication server will perform manual answer procedures for lower priority callers defined in the user access rules for a specified amount of time 206. These rules allow a user a period of time to initiate calls of her own, e.g. immediately after powering on her phone, or receive a desired high priority call placed automatically 200, and avoids the situation of immediately receiving an undesired lower priority call where the user must either accept this lower priority call and/or explain to the lower priority caller that the user desires to drop her call to either take or place another higher priority call. During this delay period 204 to 206, the communication server does not automatically answer calls from lower priority callers (in accordance with the user access rules), but instead performs manual answer procedures (in accordance with the user access rules) to allow the user to decide whether to accept or reject the incoming call depending on whether the user expects to place or receive a call to or from a higher priority user. After the delay period 206, the communication server automatically answers calls from both high priority and lower priority callers (in accordance with the user access rules). Optionally, the communication server could block any calls from these lower priority callers (in accordance with the user access rules) during this delay period 204 to 206.

Referring to FIG. 3, preferably the second embodiment of the present invention incrementally enables automatic answer of incoming calls per a prioritization of particular callers (e.g. a buddy list of the presence entity). In other words, the presence entity may provide the communication server with user access rules that define a priority of members of the presence entity's buddy list. For example, a first tier group (e.g. spouse, supervisor, VIPs, critical customers) of callers can be defined whose calls are automatically answered by the presence entity when it becomes available at time 204. A second tier group (e.g. peers, potential customers) of callers can be defined where a first delay 306 is introduced where the application server will require the presence entity to manually decide whether to accept or reject incoming calls from second tier callers. A third tier group of lower priority callers (e.g. simple acquaintances, etc.) can be defined where a second delay 308 is introduced, larger than the first delay 306, where the communication server will require the presence entity to manually decide whether to accept or reject incoming calls from third tier callers.

The delays for each tier can be predefined in the user access rules or determined empirically by the communication server. Preferably, at a particular time (e.g. 306, 308) the communication server can receive an availability level from the presence entity that indicates a particular tier or tiers, whereupon the communication server can than automatically accept calls from callers in that particular tier or tiers to the presence entity. Preferably, the delay times 306, 308 can be dynamically adjusted, such as shortening delay times if the presence entity has become newly available after a shorter interval of unavailability or in response to a decreasing number of callers of that presence entity. In addition, the delay can be increased if the number of callers or incoming calls increases, or if the presence entity has become newly available after a longer interval of unavailability. Also, the presence entity could make itself unavailable to more callers when approaching an upcoming commitment, such as a meeting time.

In practice, the delay times 306, 308 can be set and adjusted by either the communication server or the presence entity. For example, a communication server can implement a local user access rules to control automatic versus manual answer mode, wherein the MS provides an automatic answer for its first tier buddies immediately, its second tier buddies after delaying for thirty seconds (for example), and its third tier buddies after two minutes (for example). In another example, a presence entity-based incremental user access policy can be implemented when the communication server receives an availability level from an MS indicating a particular tier or tiers, when the MS is ready to accept calls from that tier or tiers, whereupon the communication server automatically answers calls from that particular tier or tiers of callers of the MS. The setting of particular delay times can be implemented anytime the presence entity updates any/specific availability information or changes to automatic answer mode.

Optionally for either embodiment, instead of defining tiers into particular buddy list members, it is also possible to define tiers in grouping of other criteria, generally grouped into the desirability to talk to a watcher, the availability of a watcher, communication conditions, and the need of the watcher. For example, priority can be based on those watchers that; a) the presence entity accepts the most or the largest fraction of calls from the most often, b) have particular presence states, c) having a particular reputation (e.g. eBay), d) having a particular location, e) the presence entity has not talked to for the longest, f) the presence entity has an unanswered query/message/voicemail for, g) the presence entity just reviewed/rendered/listen to a query message or voicemail from, which emulates what happens after a PTT but is applied to non-real-time messaging here, h) where the target and the presence entity are simultaneously free the least often, i) the presence entity recently had a call with but was dropped, j) is near the presence entity, k) is a customer that has the highest margin, gross profit, frequent buyer, or highest income, 1) have frustration in their voice, m) have waited the longest, or to give up after waiting the shortest amount time, n) are in the best RF conditions; sector load/signal strength, best voice quality, anticipated QoS, o) have the lowest mobility, p) have the lowest battery level, q) are scheduled to go busy the soonest, r) have NetMeeting, are working on the same project as me, not busy elsewhere, s) whose calls are always answered or one who has not answered my calls in the past, and t) has future availability, such as a user who is double booked with meetings or is approaching a meeting start time.

The privacy rules can be configured by either the MS (by inputs through an internet web interface or directly from a handset via an XDMC) defined in a communication standard, or configured in a communication service that learns which watchers or callers that a particular MS grants particular access. For example, the communication service can learn the most frequently accept/ignored calls given a current context, presence states, and/or call history. Similarly, the communication service can note calls from the presence entity, such as the presence entity calling a buddy that has not answered or responded, which would be granted a higher access priority by the communication service. The parameters of the privacy rules can include what presence change(s) trigger the rule, which buddies are in what tier, what is the priority order within the one tier, and what is the delay per transition, for example.

The present invention also describes a method for communication based on an availability of a presence entity in a communication network. The method includes a first step 400 of configuring at least one privacy rule for a communication service, wherein the at least one privacy rule is associated with the presence entity and assigns a potential caller to a prioritized group. Preferably, the privacy rules define prioritized groups or tiers of callers, each tier with its own priority. Preferably, an availability level of the presence entity determines which tiers are encouraged/allowed to communication with the presence entity, while the availability level may be increased or decreased over time in order to incrementally encourage/allow all prioritized groups to communicate with the presence entity or discourage/disallow all prioritized groups, respectively. Alternatively, the privacy rules can define a delay associated with each tier, such that the delay for higher priority tiers is less than the delay for lower priority tiers. Alternatively, the delays for each tier can be determined empirically by the communication service or supplied by the presence entity.

A next step 402 includes receiving an indication of availability of the presence entity. In particular, this step 402 would indicate that the presence entity has just become newly available. Preferably, the availability indication includes an availability level received at a particular time and indicating one or more prioritized groups (tiers) of callers the presence entity is willing to communicate with. This step 402 can also include receiving a second indication of availability including a second availability level at a different time and indicating a different set of prioritized groups the presence entity is willing to communicate with.

If an availability level is not being used, an optional next step 403 includes introducing the delay associated with a priority level of the potential caller.

A next step 404 includes controlling communication access with the presence entity based on the at least one privacy rule, wherein communication access between the presence entity and the caller is controlled by the prioritized group of the caller. Preferably, the communication access is also controlled in accordance with the availability indication of the presence entity, as will be detailed below. Alternatively, the communication access can also be controlled by the amount of delay associated with the prioritized group for that caller in the privacy rules, or as determined by the communication service.

In one embodiment, the communication service is a presence server, the privacy rule is a presence authorization rule, and the caller is one or more watchers of the presence entity belonging to a prioritized group, and wherein the receiving step 402 receives an indication that the presence entity has become available and an indication of the availability level of the presence entity, whereupon the controlling step 404 includes the presence server notifying the watcher of the available status of the presence entity if the watcher belongs to a prioritized group that is permitted to see the available status according to the presence entity's current availability level, and not notifying watchers of the available status who do not belong to a prioritized group indicated by the availability level. This can also include the presence server notifying one or more watchers not belonging to a prioritized group indicated by the availability level that the presence entity is at least one of the group of unavailable and availability unknown, and not notifying watchers who belong to a prioritized group indicated by the availability level. Alternatively, rather than using an availability level of the presence entity, the presence server notifies watchers of all prioritized groups of the available status of the presence entity, but only after a delay where the amount of delay for these notifications is included in the associated presence authorization rule or can be determined by the presence server. Where tiers are present, this embodiment can include notifying watchers using notification delays that are inversely proportional to the priority of the watcher.

Preferably, the receiving step 402 receives an availability level at a particular time from the presence entity that indicates at least one particular watcher prioritized group (tier), whereupon the controlling step 404 includes the presence server notifying a watcher of that at least one particular watcher prioritized group of the availability of the presence entity directly after the time of receiving the availability level. If a second availability level is received 402, then the controlling step 404 can notifying one or more watchers belonging to a prioritized group indicated by the second availability level that the presence entity is available. In this case, watchers belonging to a prioritized group indicated by both the first and second availability level are not notified after receiving the second availability level, since they were previously notified after the receiving the first availability level and the presence entity's available status has presumably not changed. Optionally, the receiving step 402 can include receiving a cancellation of the first availability level, or the controlling step 404 includes the first availability level expiring.

In these cases, the presence source can publish an availability level that is used when evaluating the privacy rules to determine what watcher (tier) is authorized. For example, the presence server might receive 402 an indication that the presence entity is available but that the availability level is only to a high prioritized group (tier) watcher, or the presence server might receive 402 an indication that the presence entity is available but that the availability level is only to high and mid prioritized group (tier) watchers, or the presence server might receive 402 an indication that the presence entity is available and that the availability level is to high, mid, and low prioritized group (tier) watchers. Alternatively, different availability level communications can be sent by the presence entity to the communication service at different times for different groups of watchers (tiers). Additionally, the availability level can expire, or the presence source cancels the publication of availability level to the presence server, so that in the absence of an availability level the default for the presence server is “available to all watchers”. In this embodiment, the authorization of any authorized watchers occurs directly after the publication of the availability level state of the presence entity received by the presence server.

In another embodiment, the communication service is a communication server and the privacy rule is a user access rule, and wherein the receiving step 402 receives an indication that the presence entity has become available, whereupon the controlling step 404 includes the communication server performing manual answer mode procedures for the amount of delay associated with the prioritized group for that caller in the associated user access rule. In one instance, the amount of delay is included in the associated user access rule or can be determined by the communication server. Where tiers are present, this embodiment includes the communication server performing automatic answer mode procedures using delays that are inversely proportional to the prioritized group of the caller.

Preferably, the receiving step 402 receives an availability level at a particular time from the presence entity that indicates at least one particular caller prioritized group (tier), whereupon the controlling step 404 includes the communication server performing automatic answer mode procedures for calls from that at least one particular caller prioritized group (tier) to the presence entity directly after the time of receiving the availability level, and perform manual answer mode procedures for the prioritized group of callers not indicated by the availability level.

In this case, the presence source can publish an availability level that is used when evaluating the privacy rules to determine what caller (tier) is authorized. For example, the communication server might receive 402 an indication that the presence entity is available but that the availability level is only to a high prioritized group (tier) caller, or the communication server might receive 402 an indication that the presence entity is available but that the availability level is only to high and mid prioritized group (tier) callers, or the communication server might receive 402 an indication that the presence entity is available and that the availability level is to high, mid, and low prioritized group (tier) callers. Alternatively, different availability level communications can be sent by the presence entity to the communication service at different times for different callers (tiers). Additionally, the availability level can expire, or the presence source cancels the publication of availability level to the communication server, so that in the absence of an availability level the default for the communication server is “available to all callers”. Therefore, in this embodiment, the automatic answering of any authorized caller occurs directly after the publication of the availability level state of the presence entity received by the communication server.

Optionally in step 404, in the first embodiment the communication server can send a warning to a caller in accordance with the presence authorization rules, and to the effect that that the presence entity will not be available at a particular future time.

In a specific embodiment, the present invention introduces a <level> element that is an extension to Presence Information Data Format (PIDF) that is used to describe the level of willingness to receive incoming communication requests, relative to the priority (i.e. prioritized group) of the watcher. The <level> element can be used as a child element of the <tuple> element as defined in RFC3863. The <level> element includes a decimal value between zero and one inclusive with at most two digits after the decimal point. Lower values indicate a willingness to communicate with only watchers of greater priority (i.e. prioritized group). Of course it should be recognized that there are many possible ways to indicate ‘willingness level”, and that the scope of the present invention incorporates these different ways.

Specifically, the present invention introduces a <min-level> element that assigns a relative priority to the set of Watchers matching the rule. The <min-level> element has a value between zero (the default value in the absence of the element) and one, up to a maximum of two decimal places. Permission is granted to see a particular service occurrence if the <level> (availability level) value of the service occurrence (described in [PRESDDS]) is greater than or equal to the <min-level> (priority) value, or if the <level> value is undefined (i.e. not published). It should be noted that if the <level> value of the service occurrence is less than the <min-level> value, local policy may instead enable polite blocking that indicates to the caller that the presence entity is unavailable.

It will be understood that the terms and expressions used herein have the ordinary meaning as is accorded to such terms and expressions by persons skilled in the field of the invention as set forth above except where specific meanings have otherwise been set forth herein.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method for communication based on an availability of a presence entity in a communication network, the method comprising the steps of:
configuring at least one privacy rule for a communication service, wherein the at least one privacy rule is associated with the presence entity and assigns a potential caller to a prioritized group;
receiving an indication of availability of the presence entity;
controlling communication access with the presence entity based on the at least one privacy rule, wherein communication access between the presence entity and the caller is controlled by the prioritized group of the caller and the availability indication of the presence entity.

2. The method of claim 1, wherein in the receiving step the availability indication includes an availability level indicating one or more prioritized groups of callers the presence entity is willing to communicate with.

3. The method of claim 2, wherein the communication service is a presence server, the privacy rule is a presence authorization rule, and the caller is a watcher of the presence entity, and wherein the receiving step receives the availability level at a particular time, whereupon the controlling step includes the presence server notifying one or more watchers belonging to a prioritized group indicated by the availability level at that particular time that the presence entity is available, and not notifying watchers who do not belong to a prioritized group indicated by the availability level that the presence entity is available.

4. The method of claim 3, wherein the receiving step includes
receiving a second availability level indicating one or more prioritized groups the presence entity is willing to communicate with, and the controlling step includes
notifying one or more watchers belonging to a prioritized group indicated by the second availability level but not the first availability level that the presence entity is available.

5. The method of claim 4, wherein the receiving step includes at least one of the group of: receiving a second availability indication that includes the second availability level, receiving a cancellation of the first availability level, and wherein the controlling step includes the first availability level expiring.

6. The method of claim 2, wherein the communication service is a presence server, the privacy rule is a presence authorization rule, and the caller is a watcher of the presence entity, whereupon the controlling step includes the presence server notifying one or more watchers not belonging to a prioritized group indicated by the availability level that the presence entity is at least one of the group of unavailable and availability unknown, and not notifying watchers who belong to a prioritized group indicated by the availability level.

7. The method of claim 2, wherein the communication service is a communication server and the privacy rule is a user access rule, and wherein the receiving step receives an the availability level at a particular time, whereupon the controlling step includes the communication server performing automatic answer mode procedures after that particular time for the caller belonging to a prioritized group indicated by the availability level, and performing manual answer mode procedures for the caller who does not belong to a prioritized group indicated by the availability level.

8. The method of claim 7, wherein the receiving step includes
receiving a second availability level indicating one or more prioritized groups the presence entity is willing to communicate with, and the controlling step includes
performing automatic answer mode procedures for the caller belonging to a prioritized group indicated by the second availability level.

9. The method of claim 8, wherein the receiving step includes at least one of the group of: receiving a second availability indication that includes the second availability level, receiving a cancellation of the first availability level, and wherein the controlling step includes the first availability level expiring.

10. The method of claim 1, further comprising the step of introducing a delay from the privacy rules associated with the prioritized group of the potential caller.

11. The method of claim 1, further comprising the step of introducing a delay that is dynamically adjustable in response to at least one of the group of: proportional to an amount of time the presence entity was unavailable, proportional to the number of watchers for that presence entity.

12. The method of claim 10, wherein the communication service is a presence server, the privacy rule is a presence authorization rule, and the caller is a watcher of the presence entity, and wherein the receiving step receives an indication that the presence entity has become available, whereupon the controlling step includes the presence server notifying the watcher of the available status of the presence entity after waiting the amount of delay associated with the prioritized group for that watcher.

13. The method of claim 10, wherein the communication service is a communication server and the privacy rule is a user access rule, and wherein the receiving step receives an indication that the presence entity has become available, whereupon the controlling step includes the communication server performing manual answer mode procedures for the amount of delay associated with the prioritized group for that caller, and performing automatic answer mode procedures following the delay associated with the prioritized group for that caller.

14. The method of claim 10, wherein the at least one privacy rule of the configuring step defines tiers of callers with each tier having its own priority associated therewith.

15. The method of claim 6, wherein the controlling step includes sending a warning to the caller that the presence entity will not be available at a particular future time.

16. A method for communication based on an availability of a presence entity in a communication network, the method comprising the steps of:
configuring a plurality of privacy rules for a communication service, wherein the privacy rules are associated with the presence entity and assign potential callers to prioritized groups;
receiving an availability level at a particular time indicating the prioritized group of callers the presence entity is willing to communicate with;
controlling communication access with the presence entity based on the privacy rules, wherein communication access between the presence entity and any caller is controlled by the prioritized group of the caller and the time that the availability level of the presence entity is received.

17. The method of claim 16, wherein the communication service is a presence server, the privacy rules are presence authorization rules, and the callers are watchers of the presence entity, and wherein the controlling step includes the presence server notifying the prioritized groups of watchers indicated by the availability level at that particular time that the presence entity is available, and not notifying the prioritized groups not indicated by the availability level that the presence entity is available.

18. The method of claim 16, wherein the communication service is a communication server and the privacy rules are user access rules, and wherein the controlling step includes the communication server performing automatic answer mode procedures after that particular time for the prioritized group of callers indicated by the availability level, and performing manual answer mode procedures for the prioritized group of callers not indicated by the availability level.

19. The method of claim 16, wherein the prioritized groups are defined per criteria based on at least one of the group of: the desirability to talk to a watcher, the availability of a watcher, communication conditions, and the need of the watcher.

20. A system for communication based on an availability of a presence entity in a communication network, the system comprising:
a presence entity operable to configuring at least one privacy rule for a communication service, wherein the at least one privacy rule is associated with the presence entity and assigns a potential caller to a prioritized group;
at least one potential caller of the presence entity; and
a communication service operable to; receive the at least one privacy rule and receive an indication of availability of the presence entity, and control communication access with the presence entity based on the at least one privacy rule, wherein communication access between the presence entity and the caller is controlled by the prioritized group of the caller and the availability indication of the presence entity.
